(19) United States
(12) Patent Application Publication
(10) Pub. No.: US 2026/0340543 A1
(43) Pub. Date: Oct. 29, 2026

(54) Multi-Layered Semantic Operating System and Semantic Task Routing Control Method

(71) Applicant: CHEN-YU HSIEH, Kaohsiung City (TW)

(72) Inventor: CHEN-YU HSIEH, Kaohsiung City (TW)

(21) Appl. No.: 19/645,812

(22) Filed: Apr. 13, 2026

Related U.S. Application Data
(60) Provisional application No. 63/794,321, filed on Apr. 24, 2025.

(51) Int. Cl. G06Q 10/0631; G06F 40/30

(52) U.S. Cl. CPC G06Q 10/06316; G06F 40/30

(57) ABSTRACT

A multi-layered semantic operating system enables a user to interact with an artificial intelligence module. The system includes an interaction layer, a data layer, a semantic processing core layer, a task planning layer and a task execution layer. The interaction layer includes an interaction module connected to the artificial intelligence module. The data layer includes a structured data storage module connected to the interaction module. The semantic processing core layer includes a semantic processing module connected to the structured data storage module. The task planning layer includes a semantic arbitration module connected to the semantic processing module. The task execution layer includes a task execution module connected to the interaction module and the semantic routing module.

This application claims priority of U.S. Provisional Application No. 63/794,321 filed on Apr. 24, 2025 under 35 U.S.C. § 119(e), the entire contents of all of which are hereby incorporated by reference.

### TECHNICAL FIELD

This application relates to an operating system and control method, and in particular to, a multi-layered semantic operating system and semantic task routing control method.

### BACKGROUND

The primary challenge in existing AI technology applications is the lack of a structured semantic framework that enables AI to comprehensively understand diverse contexts, make informed judgments, and perform multi-task operations effectively. Without such a framework, AI systems struggle to interpret human language accurately and operate in a controlled, reliable manner.

### SUMMARY

The system disclosed herein optionally incorporates a vector-based semantic field mapping mechanism. This mechanism represents semantic information as vectors and dynamically maps or organizes these vectors to reflect relationships within a semantic field. It supports dynamic storage updates to incorporate new semantic data or adjust existing mappings, enhancing tasks such as natural language understanding, term clustering, and meaning-based information retrieval. The further details will be elaborated in a separate provisional patent filing.

One or more embodiments disclosed herein describe a multi-layered semantic operating system, enabling at least one user to interact with at least one artificial intelligence module, comprising an interaction layer, a data layer, a semantic processing core layer, a task planning layer, and a task execution layer.

The interaction layer comprises an interaction module optionally connected to the artificial intelligence module. The interaction module allows the user to input at least one interactive input data, and outputs at least one interactive output data to the user.

The data layer comprises a structured data storage module optionally connected to the interaction module. The structured data storage module stores at least one structured data, including at least one main storage area and at least one background storage area. The main storage area stores the user's interactive input data, and the background storage area classifies and stores one or more user profile data corresponding to the user based on context and language.

The semantic processing core layer comprises at least one semantic processing module optionally connected to the structured data storage module. The semantic processing module formulates the data stored in the main storage area using the data stored in the background storage area and processes it into at least one semantically integrated data with contextual relevance.

The task planning layer comprises a semantic arbitration module optionally connected to the semantic processing module, and a semantic routing module optionally connected to the semantic arbitration module. The semantic arbitration module analyzes the semantically integrated data to generate an interactive input semantic, and the semantic routing module analyzes the interactive input semantic with the artificial intelligence module to generate at least one semantic task.

The task execution layer comprises a task execution module optionally connected to the interaction module and the semantic routing module. The task execution module interacts with the artificial intelligence module using the semantic task to obtain at least one artificial intelligence response data, and the task execution module transmits the artificial intelligence response data to the interaction module as the interactive output data.

In some embodiments, the data stored in the background storage area comprises contextual elements of people, events, time, location, objects, and/or cultural power relations associated with the main storage area.

In some embodiments, the semantic processing core layer further comprises a semantic memory module optionally connected to the semantic processing module, and the semantic memory module dynamically stores and dynamically adjusts the semantically integrated data.

In some embodiments, the semantic processing core layer further comprises a semantic event bus module optionally connected to one or more semantic processing modules, the semantic event bus module receives the structured data stored in the structured data storage module and provide it to one or more semantic processing modules to generate the required semantically integrated data based upon corresponding contextual relevance.

In some embodiments, the semantic event bus module is connected to at least one input device, the input device provides at least one device input data, and the semantic event bus module streams the device input data to the semantic processing module.

In some embodiments, the semantic processing core further comprises a semantic firewall module optionally connected to the semantic processing module, and the semantic firewall module is used to control the authority to obtain the required semantically integrated data.

In some embodiments, the task execution layer further comprises an artificial intelligence management module optionally connected to the task execution module, and the artificial intelligence management module manages the artificial intelligence modules required to be referenced according to the semantic task.

In some embodiments, the task execution layer further comprises a runtime policy module optionally connected to the task execution module, and an execution dispatching module optionally connected to the task execution module, the runtime policy module is used to provide runtime interaction policies with the artificial intelligence module, and the execution dispatching module is used to schedule the priority of the executed tasks.

One or more embodiments disclosed herein describe a semantic task routing control method, comprising a data collection step, a semantic analysis step, a semantic arbitration step, a process execution step, and an interactive output step.

In the data collection step, at least one interactive input data and at least one device input data, or either one of them is collected to determine a required structured data and store it in a structured data storage module;

In the semantic analysis step, the structured data is transmitted to a semantic processing module, and the semantic processing module analyzes the semantics of the structured data to obtain a semantically integrated data with contextual relevance;

In the semantic arbitration step, a semantic arbitration module analyzes the semantically integrated data according to one or more user profile data to obtain an interactive input semantic, while a semantic routing module, based on the arbitration of the interactive input semantic, restricts the structured data accessible by the multi-layered semantic operating system and at least one artificial intelligence module that can be accessed, and outputs a semantic task;

In the process execution step, a task execution module interacts with the artificial intelligence module according to the semantic task to obtain at least one artificial intelligence response data; and

In the interactive output step, the task execution module transmits the artificial intelligence response data to an interaction module as at least one interactive output data.

In some embodiments, in the data collection step, the user profile data has identity information, and at least one device background data has usage permission data, while in the semantic arbitration step, a semantic firewall module blocks the device input data according to the identity information and the usage permission data, thereby restricting the device input data that the artificial intelligence module can access in the task execution step.

In some embodiments, in the semantic arbitration step, the semantic arbitration module is optionally connected to the semantic firewall module, and the semantic arbitration module analyzes whether the semantic task and/or the artificial intelligence response data contains restricted information based on the identity information and the usage permission data.

In some embodiments, in the semantic arbitration step, the semantic task generated by the semantic routing module has a plurality of guiding instructions, the artificial intelligence module has a plurality of artificial intelligence underlying components, while in the process execution step, the task execution module accesses the corresponding artificial intelligence underlying components according to the plurality of guiding instructions.

In some embodiments, in the data collection step, the user profile data has identity information, while in the semantic arbitration step, the semantic routing module generates the plurality of guidance instructions from the interactive input semantic according to the identity information.

In some embodiments, the semantic task routing control method further comprises a data structural establishment step prior to the data collection step, wherein the data structural establishment step establishes the structured data storage module, and the at least one structured data stored in the structured data storage module includes at least one main storage area and at least one background storage area.

In some embodiments, the semantic task routing control method further comprises a data processing step after the interactive output step. The semantic processing module releases the semantically integrated data, the semantic arbitration module releases the interactive input semantic, and the semantic routing module releases the semantic task.

In some embodiments, the structure data storage module has at least one main storage area and at least one background storage area. The main storage area stores the interactive input data of the user and the device input data. For example, the interactive input data and the device input data are not directly stored in the main storage area, but are transformed through a data structure to ensure a unified data structure for the data stored in the main storage area.

In some embodiments, the interaction layer further includes a data structure computing module optionally connected to the interactive module, configured to first store data of different structures, then perform computations based on the characteristics of each data structure, and store the data in the main storage area after obtaining data of the same structure.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1-5 are flowcharts of a multi-layered semantic operating system.

FIGS. 6-8 are flowcharts of a semantic task routing control method.

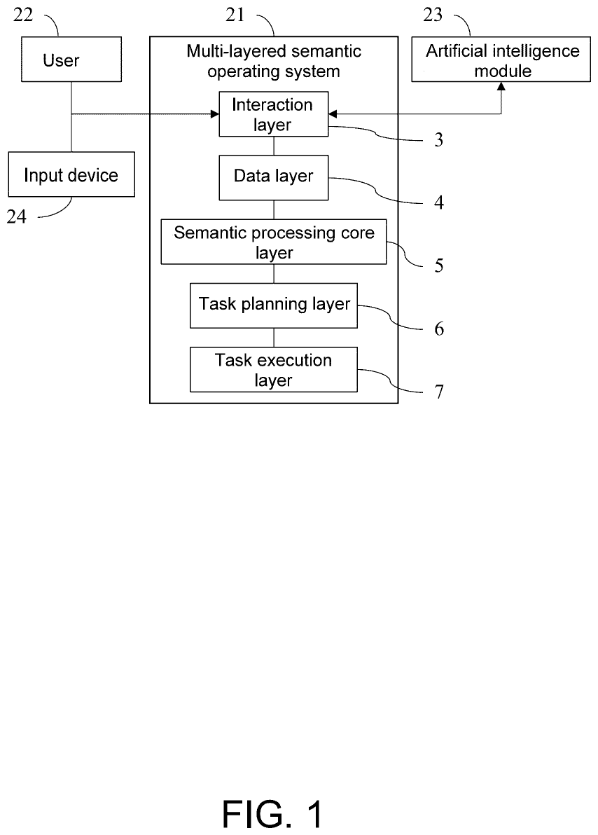

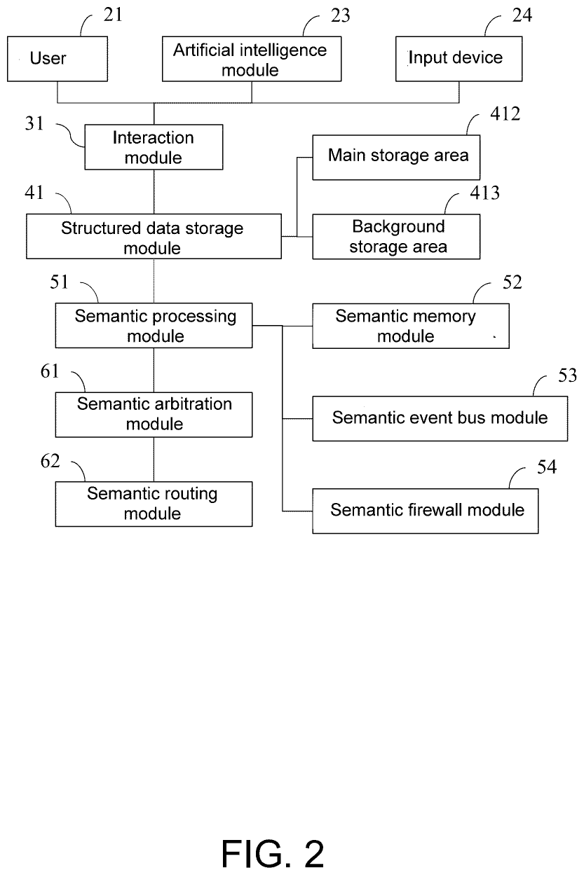

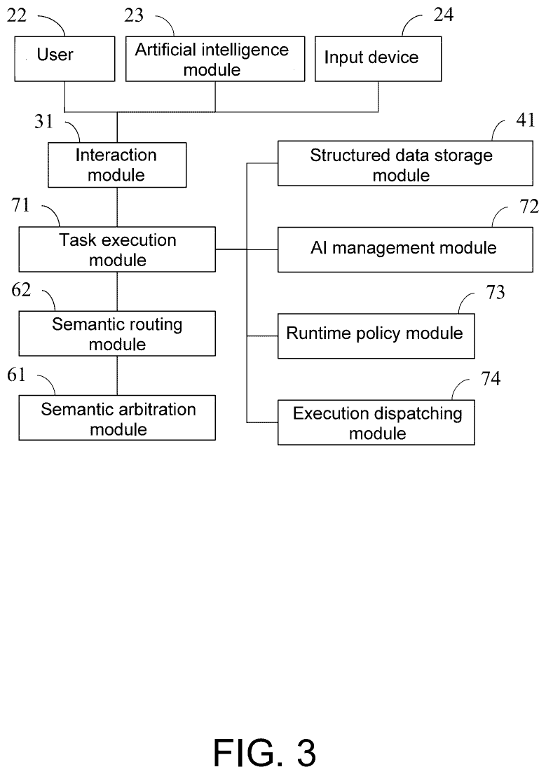

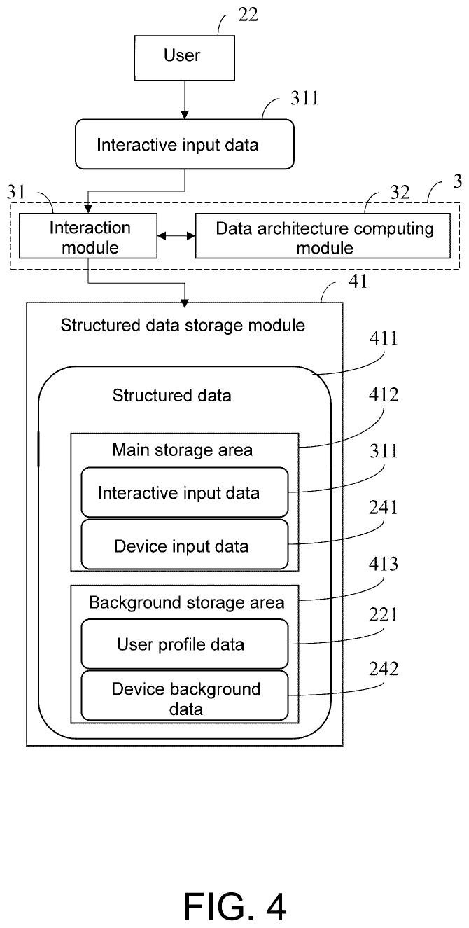

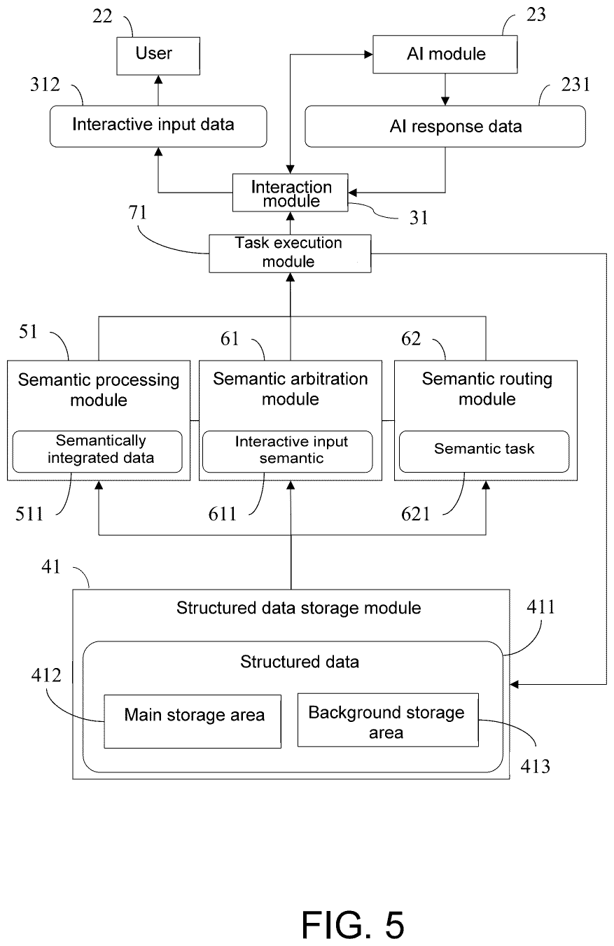

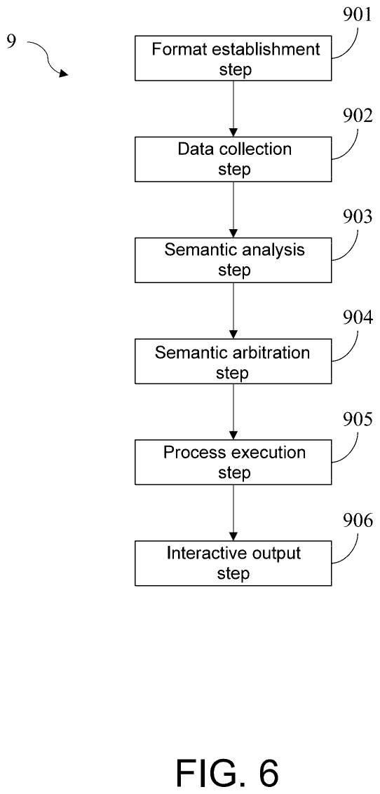

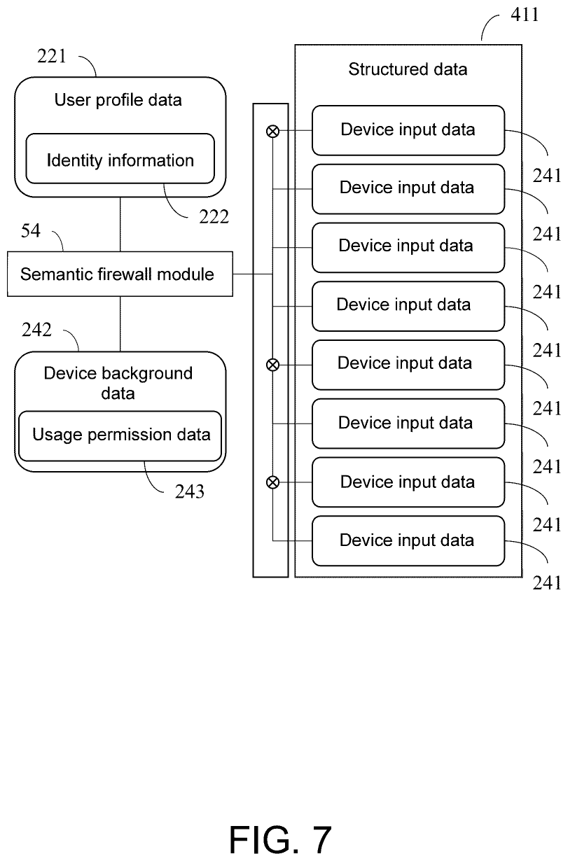

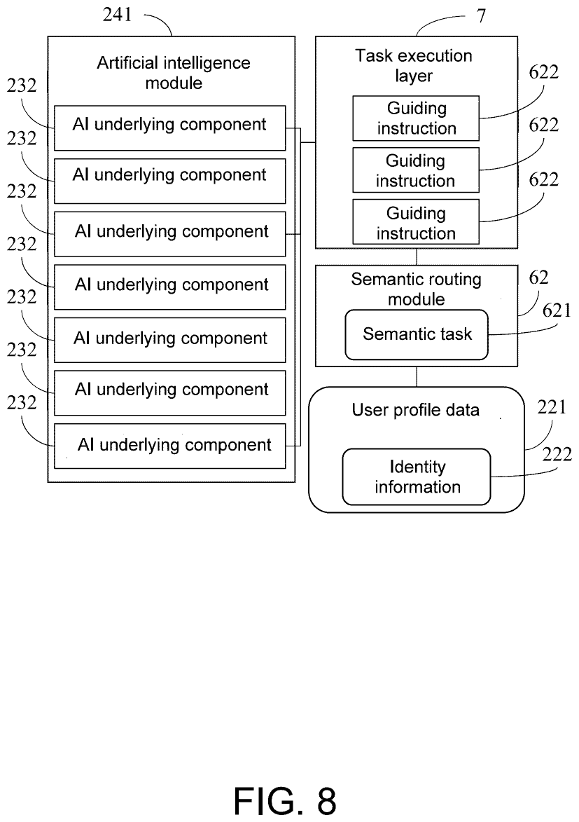

### DETAILED DESCRIPTION

The following disclosure provides many different embodiments, or examples, for implementing different features of the disclosure. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

A multi-layered semantic operating system and semantic task routing control method is disclosed to effectively addresses these challenges. It introduces a robust, structured approach to semantic processing, enabling AI to be controllable, context-aware, and capable of truly understanding human language. This system empowers AI to operate as a sophisticated, intent-driven tool that aligns with user expectations and operational constraints.

The proposed system is designed as a multi-layered architecture, with each layer performing specialized functions to process, analyze, and manage data and tasks. Below is a detailed breakdown of the system's components:

### 1. Interaction Layer (Input Layer)

The input layer is not limited to human-generated inputs (e.g., text, voice, or prompts). It encompasses a wide range of data sources, including:
(1) Device-driven inputs: Sensor data, IoT (Internet of Things) device outputs, and machine-generated telemetry (e.g., Agrion or industrial IoT systems).
(2) Surrounding inputs: Contextual data from external systems, such as weather, location, or operational metrics.
   This layer ensures that all relevant data, regardless of source, can be ingested and standardized for further processing, creating a unified input pipeline for the system.

### 2. Data Layer (Unified Semantic Data Layer, USDL)

The USDL serves as the centralized repository for all collected data, aggregating inputs from the interactive layer. Key features include:
(1) Data consolidation: Structured and unstructured data are stored in a unified format, enabling seamless access and retrieval.
(2) Metadata enrichment: Data is tagged with contextual metadata (e.g., source, timestamp, or relevance) to facilitate semantic processing.
(3) Scalability: The USDL is designed to handle large-scale, heterogeneous datasets, ensuring compatibility with diverse applications.

### 3. Semantic Processing Core Layer (Context Layer)

The context layer is the heart of the system, responsible for semantic analysis and rule-based arbitration. Its primary functions include:
(1) Semantic Rule Management: Defines and enforces rules for interpreting data based on context, user intent, and operational constraints.
(2) Role-Based Logic: Manages user and device roles, ensuring that data access and processing align with predefined permissions (e.g., identity data and usage authorization).
(3) Event Handling: Processes real-time events and triggers appropriate responses based on semantic analysis.
(4) Permission Management: A semantic firewall module filters input data, blocking unauthorized or sensitive information based on user identity and device permissions, and the semantic arbitration module analyzes whether the semantic task and/or the artificial intelligence response data contains restricted information based on the identity information and the usage permission data.
(5) Prompt Validation: Before forwarding prompts to the AI, the system verifies that only permissible data is included, preventing unauthorized access or exposure of sensitive information.
(6) Output Validation: AI-generated outputs are scrutinized to ensure compliance with privacy, security, and accuracy standards, mitigating risks such as misinformation or data leakage.

### 4. Task Planning Layer (Knowledge Routing Layer)

This layer orchestrates the decision-making process for task execution, ensuring optimal use of resources and data. Key functionalities include:
(1) Data Selection: Determines which datasets are relevant for a given task, prioritizing efficiency and accuracy.
(2) Iterative Validation: Supports back-and-forth verification to refine data selection and task planning, ensuring the best possible outcomes.
(3) Constraint Application: Enforces restrictions on AI reasoning, such as limiting access to specific data types or imposing ethical boundaries.
(4) Dynamic Optimization: Adapts task plans in real-time based on new inputs or changing contexts, enhancing flexibility and responsiveness.

### 5. Task Execution Layer (Task Routing Layer)

The task execution layer translates plans into actions, leveraging a suite of tools to manage and execute tasks efficiently. Its components include:
(1) AI Resource Manager: Allocates computational resources to suitable AI models based on task requirements, optimizing performance and scalability.
(2) Execution Scheduler: Prioritizes and sequences tasks to ensure timely and accurate completion.
(3) Runtime Policy Enforcement: Monitors task execution to enforce compliance with predefined rules, such as data privacy or operational limits.
(4) Feedback Loop: Captures execution outcomes to refine future task planning and improve system performance over time.

Unlike conventional AI systems that focus solely on integrating and scaling AI models, this disclosure establishes a semantic-centric ecosystem. It manages multiple semantic worlds (contextual domains) and context flows (dynamic interactions between contexts), enabling AI to:
(1) Understand Human Language: By leveraging structured semantic processing, the system interprets user intent with high fidelity, bridging the gap between human communication and machine understanding.
(2) Ensure Controllability and Governance Compliance: Through rigorous permission management, data filtering, output validation, and adherence to governance compliance standards, the system guarantees that AI operates within safe, ethical and regulatory boundaries.
(3) Enable Multi-Tasking: The task planning and routing layers allow the system to handle complex, multi-step tasks across diverse domains, from IoT-driven automation to user-driven queries.
(4) Mitigate Risks: By embedding safeguards like the semantic firewall and output validation, the system prevents issues such as data breaches, misinformation, or unintended AI behavior.

The present disclosure represents a paradigm shift in AI technology. By addressing the critical pain points of unstructured semantics and uncontrolled AI behavior, this disclosure delivers a robust, scalable, and controllable AI framework. It empowers AI to truly understand human language, operate reliably in diverse contexts, and execute tasks with precision and accountability. This system is poised to redefine how AI interacts with users, devices, and data, paving the way for smarter, safer, and more intuitive AI applications.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A multi-layered semantic operating system, enabling at least one user to interact with at least one artificial intelligence module, comprising:
an interaction layer, comprising an interaction module optionally connected to the artificial intelligence module, wherein the interaction module allows the user to input at least one interactive input data, and outputs at least one interactive output data to the user;
a data layer, comprising a structured data storage module optionally connected to the interaction module, wherein the structured data storage module stores at least one structured data, including at least one main storage area and at least one background storage area, the main storage area stores the user's interactive input data, and the background storage area classifies and stores one or more user profile data corresponding to the user based on context and language;
a semantic processing core layer, comprising at least one semantic processing module optionally connected to the structured data storage module, wherein the semantic processing module analyzes the data stored in the main storage area using the data stored in the background storage area and processes it into at least one semantically integrated data with contextual relevance;
a task planning layer, comprising a semantic arbitration module optionally connected to the semantic processing module, and a semantic routing module optionally connected to the semantic arbitration module, wherein the semantic arbitration module analyzes the semantically integrated data to generate an interactive input semantic, and the semantic routing module analyzes the interactive input semantic with the artificial intelligence module to generate at least one semantic task; and
a task execution layer, comprising a task execution module optionally connected to the interaction module and the semantic routing module, wherein the task execution module interacts with the artificial intelligence module using the semantic task to obtain at least one artificial intelligence response data, and the task execution module transmits the artificial intelligence response data to the interaction module as the interactive output data.

2. The multi-layered semantic operating system of claim 1, wherein the interaction module is optionally connected to at least one input device, the input device inputs at least one device input data and at least one device background data to the interaction module, the main storage area stores the device input data, the background storage area stores the device background data, and the input device is selected from the group consisting of a user input device, a device input device, a proxy input device, and an Internet of Things input device, or a combination thereof.

3. The multi-layered semantic operating system of claim 1, wherein the data stored in the background storage area comprises contextual elements of people, events, time, location, objects, and/or cultural power relations associated with the main storage area.

4. The multi-layered semantic operating system of claim 1, wherein the semantic processing core layer further comprises a semantic memory module optionally connected to the semantic processing module, and the semantic memory module dynamically stores and dynamically adjusts the semantically integrated data.

5. The multi-layered semantic operating system of claim 1, wherein the semantic processing core layer further comprises a semantic event bus module optionally connected to one or more semantic processing modules, the semantic event bus module receives the structured data stored in the structured data storage module and provide it to one or more semantic processing modules to generate the required semantically integrated data.

6. The multi-layered semantic operating system of claim 5, wherein the semantic event bus module is optionally connected to at least one input device, the input device provides at least one device input data, and the semantic event bus module streams the device input data to the semantic processing module.

7. The multi-layered semantic operating system of claim 1, wherein the semantic processing core further comprises a semantic firewall module optionally connected to the semantic processing module, and the semantic firewall module is used to control the authority to obtain the required semantically integrated data.

8. The multi-layered semantic operating system of claim 1, wherein the task execution layer further comprises an artificial intelligence management module optionally connected to the task execution module, and the artificial intelligence management module manages the artificial intelligence modules required to be referenced according to the semantic task.

9. The multi-layered semantic operating system of claim 1, wherein the task execution layer further comprises a runtime policy module optionally connected to the task execution module, and an execution dispatching module optionally connected to the task execution module, the runtime policy module is used to provide runtime interaction policies with the artificial intelligence module, and the execution dispatching module is used to schedule the priority of the executed tasks.

10. A semantic task routing control method, applicable to the multi-layered semantic operating system of claims 1, comprising:
a data collection step, wherein at least one interactive input data and at least one device input data, or either one of them is collected to determine a required structured data and store it in a structured data storage module;
a semantic analysis step, wherein the structured data is transmitted to a semantic processing module, and the semantic processing module analyzes the semantics of the structured data to obtain a semantically integrated data with contextual relevance;
a semantic arbitration step, wherein a semantic arbitration module analyzes the semantically integrated data according to one or more user profile data to obtain an interactive input semantic, while a semantic routing module, based on the arbitration of the interactive input semantic, restricts the structured data accessible by the multi-layered semantic operating system and at least one artificial intelligence module that can be accessed, and outputs a semantic task;
a process execution step, wherein a task execution module interacts with the artificial intelligence module according to the semantic task to obtain at least one artificial intelligence response data; and
an interactive output step, wherein the task execution module transmits the artificial intelligence response data to an interaction module as at least one interactive output data.

11. The semantic task routing control method of claim 10, wherein in the data collection step, the user profile data has identity information, and at least one device background data has usage permission data, while in the semantic arbitration step, a semantic firewall module blocks the device input data according to the identity information and the usage permission data, thereby restricting the device input data that the artificial intelligence module can access in the task execution step.

12. The semantic task routing control method of claim 11, wherein in the semantic arbitration step, the semantic arbitration module is optionally connected to the semantic firewall module, and the semantic arbitration module analyzes whether the semantic task and/or the artificial intelligence response data contains restricted information based on the identity information and the usage permission data.

13. The semantic task routing control method of claim 10, wherein in the semantic arbitration step, the semantic task generated by the semantic routing module has a plurality of guiding instructions, the artificial intelligence module has a plurality of artificial intelligence underlying components, while in the process execution step, the task execution module accesses the corresponding artificial intelligence underlying components according to the plurality of guiding instructions.

14. The semantic task routing control method of claim 13, wherein in the data collection step, the user profile data has identity information, while in the semantic arbitration step, the semantic routing module generates the plurality of guidance instructions from the interactive input semantic according to the identity information.

15. The semantic task routing control method of claim 10, further comprises a data structural establishment step prior to the data collection step, wherein the data structural establishment step establishes the structured data storage module, and the at least one structured data stored in the structured data storage module includes at least one main storage area and at least one background storage area.

16. The semantic task routing control method of claim 10, further comprises a data processing step after the interactive output step, wherein the semantic processing module releases the semantically integrated data, the semantic arbitration module releases the interactive input semantic, and the semantic routing module releases the semantic task.
